(19) United States
(12) Patent Application Publication
(10) Pub. No.: US 2023/0389133 A1
(43) Pub. Date: Nov. 30, 2023

(54) HEATER DEVICE

(71) Applicant: DENSO CORPORATION, Kariya-city (JP)

(72) Inventors: Yusuke TANAKA, Kariya-city (JP); Yuya SUZUKI, Kariya-city (JP); Takuya IGASHIRA, Kariya-city (JP)

(21) Appl. No.: 18/446,097

(22) Filed: Aug. 8, 2023

Related U.S. Application Data
(63) Continuation of application No. PCT/JP2022/009440, filed on Mar. 4, 2022.

(30) Foreign Application Priority Data
Mar. 26, 2021 (JP) 2021-053508

(51) Int. Cl. H05B 3/16; B60H 1/22

(52) U.S. Cl. CPC H05B 3/16; B60H 1/2218; B60H 1/2227; H05B 2203/016

(57) ABSTRACT

A heating wire having a first heating wire and a second heating wire. A receiving electrode is provided between the first heating wire and the second heating wire. A transmitting electrode includes a first transmitting electrode provided between the first heating wire and the receiving electrode, and a second transmitting electrode provided between the second heating wire and the receiving electrode. A distance between the first heating wire and the first transmitting electrode is defined as Dh1, a distance between the first transmitting electrode and the receiving electrode is defined as Ds1, a distance between the second heating wire and the second transmitting electrode is defined as Dh2, and a distance between the second transmitting electrode and the receiving electrode is defined as Ds2. A relationship of Dh1≤Ds1 and Dh2≤Ds2 is satisfied.

### CROSS REFERENCE TO RELATED APPLICATIONS

The present application is a continuation application of International Patent Application No. PCT/JP2022/009440 filed on Mar. 4, 2022, which designated the U.S. and claims the benefit of priority from Japanese Patent Application No. 2021-053508 filed on Mar. 26, 2021, the entire disclosure of the above application is incorporated herein by reference.

### TECHNICAL FIELD

The present disclosure relates to a heater device that radiates radiant heat to warm an object.

### BACKGROUND

Conventionally, there has been known a heater device that is mounted on a vehicle and warms an occupant by radiating radiant heat to the occupant.

### SUMMARY

An object of the present disclosure is to provide a heater device that can suppress thermal discomfort when an object comes into contact with the heater device and that increases the response strength of contact detection more stably.

According to one aspect of the present disclosure, a heater device includes an insulating base material, a heating wire, a receiving electrode, a transmitting electrode, and a control unit. The heating wire has a first heating wire and a second heating wire and generates heat when energized. A receiving electrode is provided between the first heating wire and the second heating wire. A transmitting electrode has a first transmitting electrode provided between the first heating wire and the receiving electrode, and a second transmitting electrode provided between the second heating wire and the receiving electrode. A control unit controls energization to the heating wire so as to set temperature of an area where the heating wire is arranged on the insulating base material to a predetermined temperature, and to reduce the amount of energization to the heating wire from a normal state or to stop the energization, when contact or proximity of an object is detected by a change in capacitance between the transmitting electrode and the receiving electrode. The first heating wire, the first transmitting electrode, the receiving electrode, the second transmitting electrode and the second heating wire extend side by side in this order on a predetermined layer of an insulating base material. A distance between the first heating wire and the first transmitting electrode is defined as Dh1, a distance between the first transmitting electrode and the receiving electrode is defined as Ds1, a distance between the second heating wire and the second transmitting electrode is defined as Dh2, and a distance between the second transmitting electrode and the receiving electrode is defined as Ds2. A relationship of Dh1≤Ds1 and Dh2≤Ds2 is satisfied.

### BRIEF DESCRIPTION OF THE DRAWINGS

FIG. 1 is a diagram illustrating a state in which a heater device is mounted on a vehicle in a first embodiment;

FIG. 2 is a plan view showing the heater device according to the first embodiment;

FIG. 3 is a cross-sectional view taken along the line III-III of FIG. 2;

FIG. 4 is an enlarged view of a portion IV of FIG. 2;

FIG. 5 is a graph showing a simulation result of thermal analysis with respect to Ds/Dh;

FIG. 6 is a graph showing a simulation result of electromagnetic field analysis with respect to Ds/Dh;

FIG. 7 is a graph showing a simulation result of surface coverage analysis of a conductive material with respect to Ds/Wi;

FIG. 8 is a graph showing a simulation result of electromagnetic field analysis with respect to Ds/Wi;

FIG. 9 is an enlarged view showing a part of a heater device according to a second embodiment, and showing a portion corresponding to FIG. 4;

FIG. 10 is a plan view showing the heater device according to a third embodiment;

FIG. 11 is an enlarged view of a portion XI in FIG. 10;

FIG. 12 is an enlarged view showing a part of a heater device of a comparative example, and showing a portion corresponding to FIG. 11;

FIG. 13 is a graph showing a simulation result of electromagnetic field analysis when a user touches a tip of a receiving electrode in the heater device of the third embodiment and the heater device of the comparative example; and

FIG. 14 is an enlarged view showing a part of a heater device according to a fourth embodiment, and showing a portion corresponding to FIG. 11.

### DETAILED DESCRIPTION

In an assumable example, there has been known a heater device that is mounted on a vehicle and warms an occupant by radiating radiant heat to the occupant. In the heater device described in the example, a heating wire is folded back at a prescribed interval in a prescribed layer of an insulating base material, and a transmitting electrode and a receiving electrode for detecting an object contact are placed between the adjacent heating wires. As a result, this heater device constitutes a planar heater that enables a single-sided substrate while improving an in-plane temperature distribution.

This heater device has a function of generating heat from the heating wire when the heating wire is energized and radiating radiant heat to the occupant. In addition, when the heater device detects that an object such as an occupant's finger is in contact with or comes close to it due to a change in the capacitance of the capacitor formed by the transmitting electrode and the receiving electrode, the heater device has a function of reducing the amount of energization to the heating wire from the normal state or stopping the energization to the heating wire.

As a result, the heater device suppresses an increase in the temperature of an object that touches the occupant-side surface, thereby preventing the occupant from feeling uncomfortable due to heat. In the following description, the capacitance of the capacitor formed by the transmitting electrode and the receiving electrode is referred to as “capacitor capacitance C”.

However, in the heater device described in the example, a heating wire, a transmitting electrode, a receiving electrode, and a heating wire are arranged in this order on a predetermined layer of an insulating base material. That is, one heating wire and a transmitting electrode are arranged adjacent to each other, and the other heating wire and a receiving electrode are arranged adjacent to each other. Therefore, when the control unit performs on/off control or duty control of energization to the heating wire so as to set the temperature of the heater device to a predetermined temperature, there is a problem that noise in contact detection increases due to large fluctuations in the capacitor capacitance C due to fluctuations in the current and voltage flowing through the heating wire.

Further, in the heater device described in the example, since a plurality of wide portions are provided at predetermined intervals over the entire receiving electrode, and a plurality of branch wirings are provided at predetermined intervals over the entire transmitting electrode, the heater device has a configuration in which the capacitor capacitance C is large, and there is also a problem that the response strength of the contact detection is weakened. In addition, the heater device described in the example has a configuration in which the conductive material provided on the insulating base material occupies a relatively large area per unit area, there is concern that an object such as an occupant's finger may make thermal discomfort. Thus, the heater device described in the example has room for further improvement in terms of suppressing thermal discomfort when an object comes into contact with it.

An object of the present disclosure is to provide a heater device that can suppress thermal discomfort when an object comes into contact with the heater device and that increases the response strength of contact detection more stably.

According to one aspect of the present disclosure, a heater device includes an insulating base material, a heating wire, a receiving electrode, a transmitting electrode, and a control unit. The heating wire has a first heating wire and a second heating wire and generates heat when energized. A receiving electrode is provided between the first heating wire and the second heating wire. A transmitting electrode has a first transmitting electrode provided between the first heating wire and the receiving electrode, and a second transmitting electrode provided between the second heating wire and the receiving electrode. A control unit controls energization to the heating wire so as to set temperature of an area where the heating wire is arranged on the insulating base material to a predetermined temperature, and to reduce the amount of energization to the heating wire from a normal state or to stop the energization, when contact or proximity of an object is detected by a change in capacitance between the transmitting electrode and the receiving electrode. The first heating wire, the first transmitting electrode, the receiving electrode, the second transmitting electrode and the second heating wire extend side by side in this order on a predetermined layer of an insulating base material. A distance between the first heating wire and the first transmitting electrode is defined as Dh1, a distance between the first transmitting electrode and the receiving electrode is defined as Ds1, a distance between the second heating wire and the second transmitting electrode is defined as Dh2, and a distance between the second transmitting electrode and the receiving electrode is defined as Ds2. A relationship of Dh1≤Ds1 and Dh2≤Ds2 is satisfied.

Generally, in a capacitive contact detection, the larger the ratio of the capacitance (hereinafter referred to as “change in capacitance ΔC”) that changes when an object such as a user's finger touches or approaches, the stronger the reaction strength, with respect to the capacitance (hereinafter referred to as “capacitance C”) of the capacitor formed by the transmitting electrode and the receiving electrode. That is, a relationship of reaction strength proportional to ΔC/C is satisfied.

In the above formula, the capacitance C is represented by a predetermined function of a value obtained by multiplying a shape characteristics of the electrode and a length of the electrode. That is, a relationship of C=f (shape characteristic×electrode length) is satisfied. On the other hand, the change in capacitance ΔC is represented by a predetermined function of the shape characteristics of the electrodes. That is, a relationship of ΔC=f (shape characteristic) is satisfied.

In the above formula, the shape characteristic of the parallel plate capacitor satisfies a relationship of C=εS/Ds where an area of a parallel plates is defined as S, a dielectric constant between the parallel plates is defined as s, and a distance between the parallel plates is defined as Ds. In addition, as in one aspect of the present disclosure, when the transmitting electrode and the receiving electrode are arranged in a predetermined layer of the insulating base material, an area of the surfaces of the transmitting electrode and the receiving electrode facing each other (that is, a thickness surface of the electrode whose normal is a surface direction of the insulating base material) becomes the area S of the parallel plate. Also, a distance Ds between the transmitting electrode and the receiving electrode becomes the distance Ds between the parallel plates.

On the other hand, a parabolic electric line of force is formed between the transmitting electrode and the receiving electrode, in a direction perpendicular to the surface of the insulating substrate (hereinafter, “Z direction”) and in a direction in which the transmitting electrode and the receiving electrode face each other (that is, the surface direction of the insulating substrate). When an object comes into contact with or approaches the transmitting electrode and the receiving electrode through a skin material or the like, the change in capacitance ΔC tends to reflect the influence of the electric line of force in the Z direction. Furthermore, the system becomes complicated if heat flow related to temperature distribution is taken into account, but the discloser has found an effective shape while continuing their earnest research.

In the heater device described in the example cited as the prior art document, the first heating wire, the transmitting electrode, the receiving electrode, and the second heating wire are arranged in this order on a predetermined layer of the insulating base material. In the case of this arrangement, when the control unit controls the energization of the heating wire, due to fluctuations in the current and voltage flowing through the first heating wire and the second heating wire, the capacitance C formed between the transmitting electrode and the receiving electrode fluctuates greatly. As a result, there was a problem that the noise of contact detection is increased.

On the other hand, in one aspect of the present disclosure, In the heater device, a first transmitting electrode and a second transmitting electrode are arranged so as to interpose a receiving electrode and a first heating wire and a second heating wire are arranged outside of the first transmitting electrode and the second transmitting electrode in a predetermined layer of the insulating base material. As a result, when the control unit controls the energization of the heating wire, even if the current and voltage flowing through the heating wire fluctuate, the fluctuation of the capacitor capacitance C formed by the first transmitting electrode and the receiving electrode and the fluctuation of the capacitor capacitance C formed by the second transmitting electrode and the receiving electrode are reduced, and it is possible to suppress contact detection noise.

Furthermore, in one aspect of the present disclosure, the heater device is configured to satisfy a relationship of Dh1≤Ds1 and Dh2≤Ds2. Hereinafter, Dh1 and Dh2 are hereinafter simply referred to as “Dh”, and Ds1 and Ds2 are simply referred to as “Ds”. In the wiring arrangement described in one aspect of the present disclosure, the discloser conducted thermal analysis simulations and found that the higher the Ds/Dh, the higher the surface average temperature. By shortening the distance Dh between the heating wire and the transmitting electrode, the amount of heat transferred from the heating wire at high temperature to the transmitting electrode increases. As a result, it is considered that the transmitting electrode diffuses heat toward the receiving electrode and the surface average temperature rises. Furthermore, the discloser has found that there is an inflection point near Ds/Dh=1 from the simulation result of this thermal analysis.

In addition, in the arrangement of wiring described in one aspect of the present disclosure, the discloser conducted electromagnetic field analysis simulations, and found that the greater the Ds/Dh is, the more the reaction strength is improved. By increasing the distance Ds between the transmitting electrode and the receiving electrode, the capacitor capacitance C decreases. At the same time, the change in capacitance ΔC increases due to the increase in the electric lines of force in the Z direction, so it is considered that the reaction strength is improved. Furthermore, the discloser found that there is an inflection point near Ds/Dh=1 also from the simulation result of this electromagnetic field analysis. Based on these simulation results, in one aspect of the present disclosure, the heater device is configured to satisfy a relationship of Dh≤Ds (specifically, Dh1≤Ds1 and Dh2≤Ds2). As a result, the surface average temperature of the heater device can be improved, and the reaction strength can be stably increased.

Moreover, according to another aspect of the present disclosure, a heater device includes an insulating base material, a heating wire, a receiving electrode, a transmitting electrode, and a control unit. The heating wire is provided on the insulating base material and generates heat when energized. The receiving electrodes are provided linearly or curvedly on the insulating base material. A transmitting electrode having a first transmitting electrode extending in parallel with the receiving electrode, a second transmitting electrode extending in parallel with the receiving electrode on a side opposite to the first transmitting electrode with respect to the receiving electrode, and a third transmitting electrode connecting the first transmitting electrode and the second transmitting electrode on a tip portion side of the receiving electrode, and being provided so as to face three sides of the tip portion of the receiving electrode. The control unit reduces the amount of energization to the heating wire from a normal state or to stop the energization, when contact or proximity of an object is detected by a change in capacitance between the transmitting electrode and the receiving electrode. The tip portion of the receiving electrode has a higher surface density than a general portion of the receiving electrode excluding the tip portion.

According to this configuration, when the receiving electrode is formed linearly from the general portion to the tip portion, the reaction strength when an object such as a user's finger contacts or approaches the tip portion of the receiving electrode is weaker than the reaction strength when the object contacts or approaches the general portion of the receiving electrode. Therefore, in another aspect of the present disclosure, the surface density of the tip portion of the receiving electrode is higher than the surface density of the general portion of the receiving electrode excluding the tip portion. Thereby, the response strength can be ensured by increasing the change in capacitance ΔC when an object such as a user's finger contacts or approaches the tip portion of the receiving electrode. As described above, since there is a relationship of C=f (shape characteristics×electrode length), even if the surface density of the tip portion of the receiving electrode is increased, the tip portion is only a part of the entire length of the receiving electrode. Therefore, although the contribution to the capacitor capacitance C is limited, the change capacitance ΔC can be increased.

Embodiments of the present disclosure will now be described with reference to the drawings. In the following embodiments, the same or equivalent parts are denoted by the same reference numerals as each other, and explanations will be provided to the same reference numerals. The terms “upper”, “lower”, “left”, and “right” used in the following description and drawings are used for convenience of explanation, and do not limit the usage conditions of the heater device.

### First Embodiment

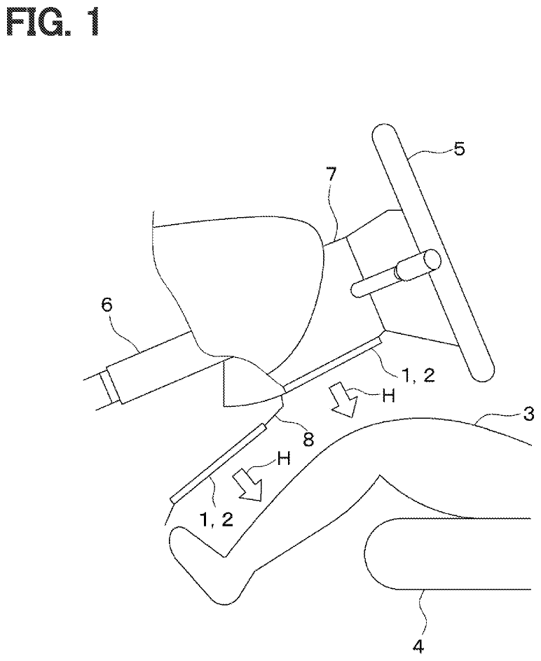

A heater device according to the first embodiment will be described. As shown in FIG. 1, a heater device 1 is installed in an interior of a moving body such as a vehicle. The heater device 1 constitutes a part of a heating device in a vehicle interior. The heater device 1 is an electric heater that generates heat by being supplied with electric power from a power supply device such as a battery or a generator mounted on a mobile object. The heater device 1 is a planar heater formed in the shape of a flexible thin plate, and has a heater main body 2 that generates heat when electric power is supplied. The heater device 1 is used mainly to radiate radiant heat H in a thickness direction of the heater main body 2 and to warm an object positioned in that direction.

The heater device 1 can be used, for example, as a device for promptly providing warmth to an occupant 3 immediately after the vehicle running engine is started. The heater device 1 is installed so as to radiate radiant heat H at the feet of the occupant 3 seated on a seat 4 in the vehicle interior. For example, the heater device 1 is installed on a lower surface of a steering column cover 7 provided to cover a steering column 6 for supporting a steering 5, or on a dashboard 8 located below the steering column cover 7. Since the heater device 1 has flexibility, it is installed along each mounting surface.

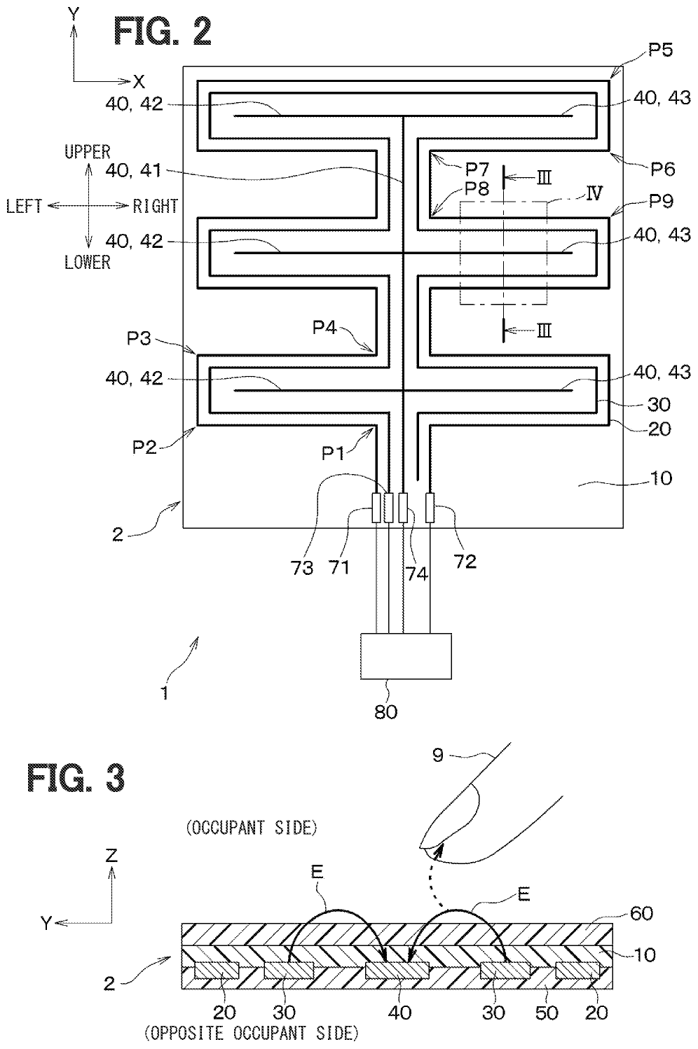

FIG. 2 is a plan view of the heater main body 2 of the heater device 1. In this state, the heater device 1 extends along the X-Y plane defined by an axis X and an axis Y. FIG. 3 is a cross-sectional view taken along line III-III of FIG. 2. As shown in FIG. 3, the heater main body 2 of the heater device 1 is formed in a thin plate shape having a thickness in the direction of an axis Z.

As shown in FIGS. 2 and 3, the heater device 1 includes an insulating base material 10, a heating wire 20, a transmitting electrode 30, a receiving electrode 40, an insulating layer 50, a skin material 60, and the like. The insulating base material 10 and the insulating layer 50 are made of a resin material (for example, a polyimide film) that has excellent electrical insulation and is resistant to high temperatures. The heating wire 20, the transmitting electrode 30 and the receiving electrode 40 are provided on the surface of the insulating base material 10 that is arranged on the side opposite to the occupant 3. That is, the heating wire 20, the transmitting electrode 30, and the receiving electrode 40 are provided in the same layer. The insulating layer 50 covers the surface of the insulating base material 10 opposite to the occupant 3, the heating wire 20, the transmitting electrode 30 and the receiving electrode 40. On the other hand, the skin material 60 is provided on the surface of the insulating base material 10 that is arranged on the occupant 3 side.

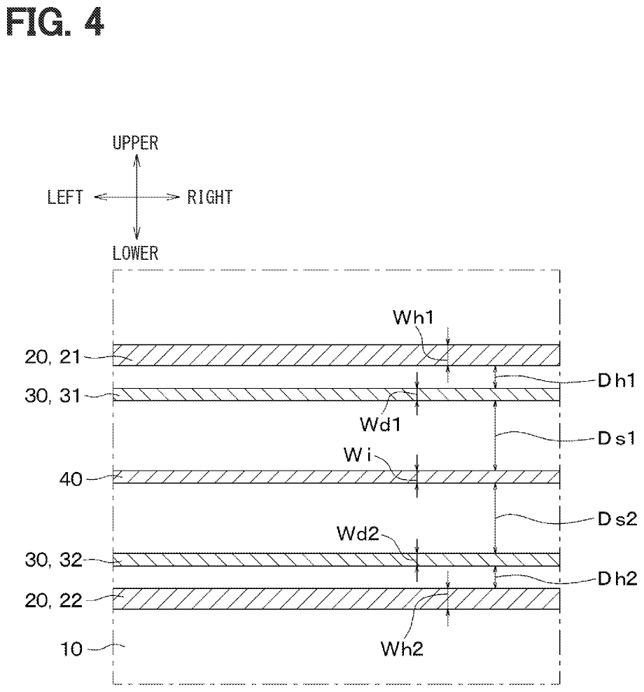

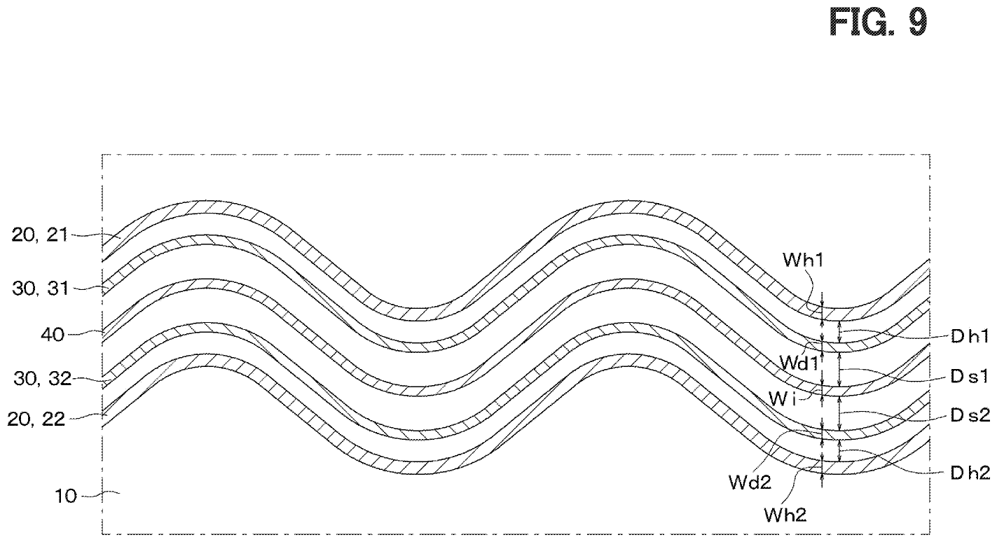

FIGS. 2 and 4 are views of the insulating base material 10 seen through the insulating layer 50 from the side opposite to the occupant 3. This view also applies to FIGS. 9 to 12 and 14, which are referred to in each embodiment and comparative example described later.

As shown in FIG. 2, the heating wire 20 is folded back at predetermined intervals so as to meander in a predetermined layer of the insulating base material 10. The heating wire 20 is made of a metal material that generates heat when energized. The transmitting electrode 30 and the receiving electrode 40 are also made of a conductive metal material.

The arrangement of each wiring (that is, the heating wire 20, the transmitting electrode 30 and the receiving electrode 40) illustrated in FIG. 2 will be described below. In the following description, for convenience of explanation, terms such as “upper”, “lower”, “left”, and “right” in the paper surface of the drawings to be referred to will be used, and those terms do not limit the state in which the heater device 1 is installed in the vehicle or the like. This explanation also applies to the description of each embodiment and comparative example that will be described later.

In the arrangement of each wiring illustrated in FIG. 2, the heating wire 20 meanders in an area on the left side of the insulating base material 10 from the positive terminal 71 provided on the insulating base material 10, and then in an area on the right side of the insulating base material 10. After that the heating wire 20 is connected to a ground terminal 72. Specifically, the heating wire 20 repeats such a shape that it extends from the positive terminal 71 to the upper side of the paper surface of FIG. 2, extends to the left side from the tip P1 thereof, extends upward from the tip P2, extends rightward from the tip P3, and extends upward from the tip P4. After that, the heating wire 20 extends from the left area of the insulating base material 10 to the right area thereof. Furthermore, the heating wire 20 repeats such a shape that it extends downward from the tip P5 extending to the right area, extends leftward from the tip P6, extends downward from the tip P7, extends rightward from the tip P8, and extends downward from the tip P9. After that the heating wire 20 is connected to the ground terminal 72.

The transmitting electrode 30 is provided along the heating wire 20 at a constant interval from the heating wire 20. That is, the transmitting electrode 30 and the heating wire 20 are provided in parallel. Specifically, the transmitting electrode 30 is provided so as to meander in the left area of the insulating base material 10 along the heating wire 20 from a first detection terminal 73 provided on the insulating base material 10. After that, the transmitting electrode 30 extends from the left area of the insulating base material 10 to the right area, and is provided so as to meander in the right area of the insulating base material 10 along the heating wire 20.

The receiving electrode 40 is provided in parallel with the transmitting electrode 30 at a constant interval from the transmitting electrode 30. Specifically, the receiving electrode 40 has a central wiring 41, a plurality of left wirings 42 and a plurality of right wirings 43. The central wiring 41 is a wiring extending upward from a second detection terminal 74 provided on the insulating base material 10. The central wiring 41 is provided between the wiring provided in the area on the left side of the insulating base material 10 among the transmitting electrodes 30 and the wiring provided in the area on the right side of the insulating base material 10 among the transmitting electrodes 30. The plurality of left wirings 42 are a plurality of wirings extending leftward from the middle or the tip of the central wiring 41. The plurality of left wirings 42 of the receiving electrode 40 are provided between wires that are folded back and adjacent to each other in the area on the left side of the insulating base material 10. The plurality of right wirings 43 are a plurality of wirings extending rightward from the middle or the tip of the central wiring 41. The plurality of right wirings 43 of the receiving electrode 40 are provided between wires that are folded back and adjacent to each other in the area on the right side of the insulating base material 10. With such an arrangement, each wiring is arranged in the order of the heating wire 20, the transmitting electrode 30, the receiving electrode 40, the transmitting electrode 30, and the heating wire 20 at various locations on the insulating base material 10.

The arrangement of each wiring shown in FIG. 2 is an example, and the arrangement of each wiring provided in the heater device 1 is not limited to this arrangement.

The positive terminal 71 and the ground terminal 72 provided at both ends of the heating wire 20 are electrically connected to a control unit 80. Therefore, energization of the heating wire 20 is controlled by the control unit 80. When a current flows through the heating wire 20 due to the energization control by the control unit 80, the heating wire 20 generates heat. The control unit 80 includes a microcontroller having a processor for performing control processing and arithmetic processing, and a storage unit, such as a ROM and a RAM, for storing programs and data. The controller also includes peripheral circuits for these components. The storage unit includes non-transitory tangible storage media. The control unit 80 detects the temperature of the area by a temperature sensor (not shown) provided in the area of the insulating base material 10 where the heating wire 20 is provided. In order to control the temperature of the area in which the heating wire 20 is provided to a predetermined target temperature, the control unit 80 performs ON/OFF control or duty control of energization to the heating wire 20.

The first detection terminal 73 provided at one end of the transmitting electrode 30 and the second detection terminal 74 provided at one end of the receiving electrode 40 are also electrically connected to a detection circuit (not shown) of the control unit 80. The control unit 80 has a function to detect contact or proximity of an object including the occupant 3 by a change in the capacitance (hereinafter referred to as “capacitor capacitance C”) stored in the capacitor formed by the transmitting electrode 30 and the receiving electrode 40. Specifically, when a pulsed voltage is applied from the detection circuit of the control unit 80 to the transmission electrode 30, an electric field is formed between the transmission electrode 30 and the reception electrode 40, and a predetermined electric charge is accumulated.

As shown in FIG. 3, when an object such as the finger 9 of the occupant 3 contacts or approaches the occupant-side surface of the heater main body 2, part of the electric lines of force E that fly in the Z direction in a parabolic shape is blocked by the object. As a result, the electric field detected by the receiving electrode 40 is reduced by blocking part of the electric lines of force E by the object, and the capacitor capacitance C formed by the transmitting electrode 30 and the receiving electrode 40 is also reduced. Therefore, the detection circuit of the control unit 80 can detect the contact or proximity of an object by catching the change in capacitance (hereinafter referred to as “change in capacitance ΔC”) that changes when an object contacts or approaches the object.

When the contact or proximity of the object is detected, the control unit 80 reduces the amount of power supplied to the heating wire 20 from the normal state or stops the power supply. The heating wire 20, the transmitting electrode 30, and the receiving electrode 40 are all formed linearly and have a low heat capacity. In addition, the heating wire 20, the transmitting electrode 30, and the receiving electrode 40 are all provided in the same layer of the insulating base material 10. Since the number of layers constituting the heater main body 2 is reduced, the total thickness of the heater main body 2 is reduced, and the amount of metal in the wiring is also reduced. Therefore, in the heater device 1, the heat capacity of the heater main body 2 is small, so that the function of rapidly lowering the temperature when the object touches can be improved.

Further, in the first embodiment, a length and width of each wiring (that is, the heating wire 20, the receiving electrode 40 and the transmitting electrode 30) provided on the insulating base material 10 are set to satisfy a formula 0.5×Sb≥Sw. In the above formula, Sb is the area of the heater main body 2 of the insulating base material 10 where each wiring (that is, the heating wire 20, the receiving electrode 40 and the transmitting electrode 30) is provided. In the above formula, Sw is the sum of the areas of the surfaces of each wiring whose normal is the thickness direction (that is, the Z direction) of the heater main body 2. As a result, the occupancy rate of the conductive material per unit area of the heater main body 2 can be reduced, and it is possible to prevent thermal discomfort from being caused when the user's finger or the like touches the heater main body 2.

Furthermore, in the heater device 1 of the first embodiment, each wiring is arranged so that the reaction intensity of contact detection when an object such as a user's finger contacts or approaches the heater main body 2 stably increases. The arrangement of each wiring in the heater device 1 of the first embodiment will be described in detail with reference to FIG. 4. In FIG. 4, each wiring is hatched although FIG. 4 is not a cross section view in order to distinguish between the insulating base material 10 and each wiring. This hatching also applies to FIGS. 9 to 12 and 14, which are referred to in embodiments and comparative examples to be described later.

As described above, each winding of the heater device 1 is arranged in the order of the heating wire 20, the transmitting electrode 30, the receiving electrode 40, the transmitting electrode 30 and the heating wire 20 at various locations on the insulating base material 10. Hereinafter, for convenience of explanation, each wiring shown in FIG. 4 is referred to as a first heating wire 21, a first transmitting electrode 31, the receiving electrode 40, a second transmitting electrode 32, and a second heating wire 22 from the upper side of the paper surface of FIG. 4.

The heating wire 20 has the first heating wire 21 and the second heating wire 22. The first transmitting electrode 31, the receiving electrode 40 and the second transmitting electrode 32 are arranged between the first heating wire 21 and the second heating wire 22. As a result, when the control unit 80 controls the energization of the heating wire 20, even if the current flowing through the heating wire 20 and voltage fluctuate, the deflection of the capacitor capacitance C formed by the first transmitting electrode 31 and the receiving electrode 40 is reduced. The deflection of the capacitor capacitance C formed by the second transmitting electrode 32 and the receiving electrode 40 is also reduced. Therefore, it is possible to suppress contact detection noise.

Here, a distance between the first heating wire 21 and the first transmitting electrode 31 is defined as Dh1, a distance between the first transmitting electrode 31 and the receiving electrode 40 is defined as Ds1, a distance between the second heating wire 22 and the second transmitting electrode 32 is defined as Dh2, and a distance between the second transmitting electrode 32 and the receiving electrode 40 is defined as Ds2. At this time, each wiring satisfies a relationship of Dh1≤Ds1 and Dh2≤Ds2.

A width of the first heating wire 21 is defined as Wh1, and a width of the second heating wire 22 is defined as Wh2. At this time, each wiring satisfies a relationship of Dh1≤Wh1 and Dh2≤Wh2.

A width of the first transmitting electrode 31 is defined as Wd1, a width of the second transmitting electrode 32 is defined as Wd2, and a width of the receiving electrode 40 is defined as Wi. At this time, each wiring satisfies a relationship of Wd1≤Wi and Wd2≤Wi. Further, each wiring satisfies a relationship of Wi≤Ds1 and Wi≤Ds2.

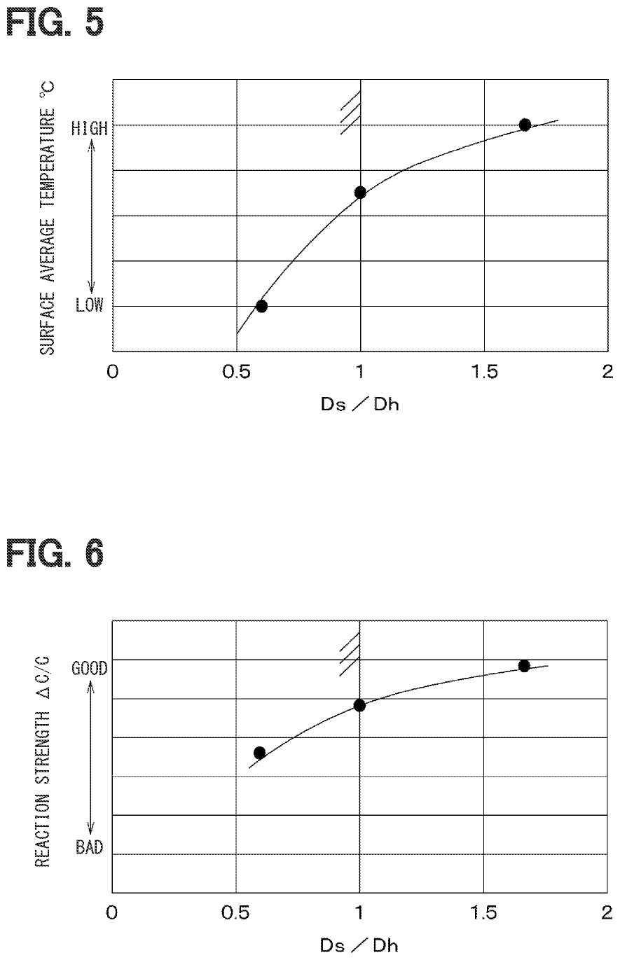

The significance of defining the distance, wire width and area of each wiring in this manner will be described below. First, the significance of the relationship of Dh1≤Ds1 and Dh2≤Ds2 will be described with reference to the graphs of FIGS. 5 and 6. Dh1 and Dh2 are hereinafter simply referred to as “Dh”, and Ds1 and Ds2 are simply referred to as “Ds”.

The graph of FIG. 5 shows a simulation result of a thermal analysis performed by the discloser regarding the arrangement relationship of each wiring. In this simulation, a surface average temperature of the heater main body 2 is calculated by changing Ds/Dh under a condition that the distance between the first heating wire 21 and the second heating wire 22 is fixed and the width of each wiring is fixed. From this simulation result, it can be seen that the larger the Ds/Dh, the higher the surface average temperature. By shortening the distance Dh between the heating wire 20 and the transmitting electrode 30, the amount of heat transferred from the heating wire 20 at high temperature to the transmitting electrode 30 increases. As a result, it is considered that the transmitting electrode 30 diffuses heat toward the receiving electrode 40 and the surface average temperature rises. Furthermore, the discloser has found that there is an inflection point near Ds/Dh=1 from the simulation result of this thermal analysis. That is, when Ds/Dh is less than 1, the surface average temperature tends to decrease rapidly. Therefore, by setting Ds/Dh to 1 or more (that is, Dh≤Ds), the surface average temperature can be stably improved.

Further, the graph of FIG. 6 shows a simulation result of the electromagnetic field analysis performed by the discloser regarding the arrangement relationship of each wiring. In this simulation as well, a reaction strength (that is, ΔC/C) is calculated by changing Ds/Dh under a condition that the distance between the first heating wire 21 and the second heating wire 22 is fixed and the width of each wiring is fixed. From this simulation result, it can be seen that the larger the Ds/Dh is, the more the reaction strength is improved. By increasing the distance Ds between the transmitting electrode 30 and the receiving electrode 40, the capacitor capacitance C decreases. At the same time, the change in capacitance ΔC increases due to the increase in the electric lines of force in the Z direction, so it is considered that the reaction strength is improved. Furthermore, the discloser found that there is an inflection point near Ds/Dh=1 also from the simulation result of this electromagnetic field analysis. That is, when Ds/Dh is less than 1, the rate of decrease in reaction strength tends to increase. Therefore, by setting Ds/Dh to 1 or more (that is, Dh≤Ds), the reaction strength can be stably increased.

Next, the significance of the relationship of Dh1≤Wh1 and Dh2≤Wh2 will be described. Dh1 and Dh2 are hereinafter simply referred to as “Dh”, and Wh1 and Wh2 are simply referred to as “Wh”.

According to this configuration, the distance Dh between the heating wire 20 and the transmitting electrode 30 is made smaller than the width Wh of the heating wire 20, and the transmitting electrode 30 is brought closer to the heating wire 20 at a high temperature. Since the amount of heat transferred to the transmitting electrode 30 from the heating wire 20 increases, the surface average temperature can be improved. In addition, while the distance between the first heating wire 21 and the second heating wire 22 is fixed, as the distance Dh between the heating wire 20 and the transmitting electrode 30 is shortened, by increasing the distance Ds between the transmitting electrode 30 and the receiving electrode 40, the reaction strength can be increased stably.

Next, the significance of the relationship of Wd1≤Wi and Wd2≤Wi will be described. Wd1 and Wd2 are hereinafter simply referred to as “Wd”. According to this configuration, since one receiving electrode 40 is interposed between the first transmitting electrode 31 and the second transmitting electrode 32, by setting the relationship of Wd≤Wi, a capacitance formation of the capacitor formed by the two transmitting electrodes 30 and one receiving electrode 40 can be stabilized.

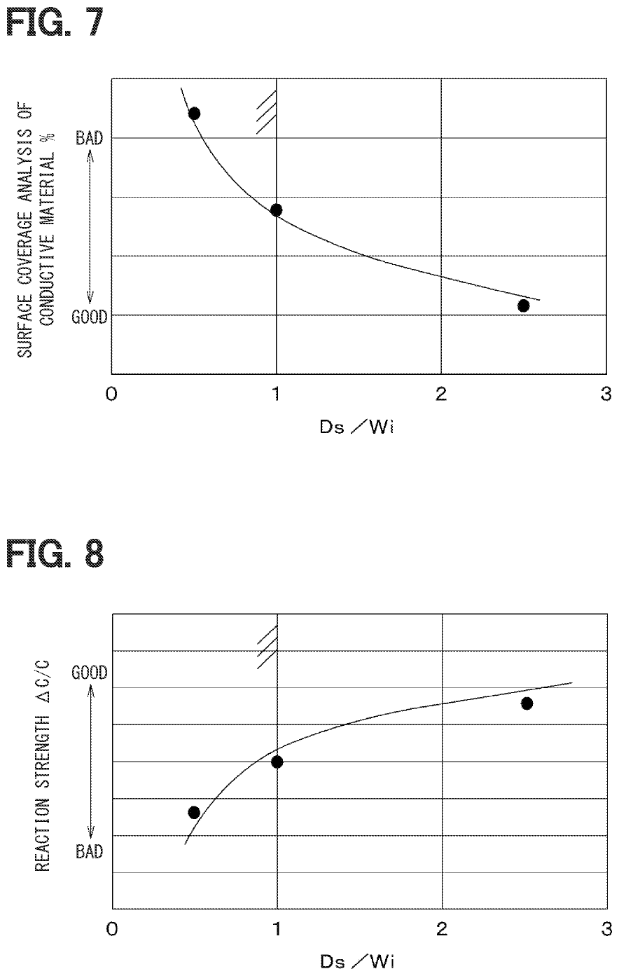

Next, the significance of the relationship of Wi≤Ds1 and Wi≤Ds2 will be described with reference to the graphs of FIGS. 7 and 8. In the following description, Ds1 and Ds2 are simply referred to as “Ds”.

The graph of FIG. 7 shows a simulation result of the surface coverage analysis of the conductive material performed by the discloser regarding the arrangement relationship of each wiring. In this simulation, the surface occupancy of the conductive material was calculated by changing Ds/Wi under a condition that the distance between the first heating wire 21 and the second heating wire 22 is fixed, and the width Wh of the heating wire 20 and the width Wd of the transmitting electrode 30 are fixed. Based on this simulation result, it can be seen that the occupancy rate of the conductive material in the heater main body 2 decreases as Ds/Wi increases. Here, from the viewpoint of suppressing thermal discomfort when a user's finger or the like touches the heater main body 2, it is advantageous to reduce the occupancy rate of the conductive material per unit area of the heater main body 2. Therefore, by increasing the distance Ds between the transmitting electrode 30 and the receiving electrode 40 and decreasing the Wi of the receiving electrode 40, the occupancy rate of the conductive material is reduced, so that thermal discomfort can be suppressed. Furthermore, the discloser has found that there is an inflection point near Ds/Wi=1 from the simulation results of surface coverage analysis of this conductive material. That is, when Ds/Wi is greater than 1, the occupancy rate of the conductive material tends to increase sharply. Therefore, by setting Ds/Wi to 1 or more (that is, Wi≤Ds), it is possible to prevent the user of the heater device 1 from feeling thermal discomfort.

Further, the graph of FIG. 8 shows a simulation result of the electromagnetic field analysis performed by the discloser regarding the arrangement relationship of each wiring. In this simulation as well, the reaction strength (that is, ΔC/C) was calculated by changing Ds/Wi under a condition that the distance between the first heating wire 21 and the second heating wire 22 is fixed, and the width Wh of the heating wire 20 and the width Wd of the transmitting electrode 30 are fixed. From this simulation result, it can be seen that the larger the Ds/Wi is, the more the reaction strength is improved. By increasing the distance Ds between the transmitting electrode 30 and the receiving electrode 40, the capacitor capacitance C decreases. At the same time, the change in capacitance ΔC increases due to the increase in the electric lines of force in the Z direction, so it is considered that the reaction strength is improved. Furthermore, the discloser found that there is an inflection point near Ds/Wi=1 also from the simulation result of this electromagnetic field analysis. That is, when Ds/Wi is less than 1, the rate of decrease in reaction strength tends to increase. Therefore, by setting Ds/Wi to 1 or more (that is, Wi≤Ds), the reaction strength can be stably increased.

The heater device 1 of the first embodiment described above has the following effects.

(1) In the heater device 1 of the first embodiment, the first transmitting electrode 31 and the second transmitting electrode 32 are arranged so as to interpose the receiving electrode 40 and the first heating wire 21 and the second heating wire 22 are arranged outside of the first transmitting electrode 31 and the second transmitting electrode 32 in a predetermined layer of the insulating base material 10. As a result, when the control unit 80 controls the energization of the heating wire 20, even if the current flowing through the heating wire 20 and voltage fluctuate, the deflection of the capacitor capacitance C formed by the first transmitting electrode 31 and the receiving electrode 40 is reduced. In addition, the deflection of the capacitor capacitance C formed by the second transmitting electrode 32 and the receiving electrode 40 is also reduced. Therefore, it is possible to suppress contact detection noise.

(2) In the first embodiment, the distance Dh between the heating wire 20 and the transmitting electrode 30 and the distance Ds between the transmitting electrode 30 and the receiving electrode 40 satisfy a relationship of Dh≤Ds. According to this relationship, as described with reference to the graphs of FIGS. 5 and 6, the surface average temperature of the heater device 1 can be improved and the reaction strength can be stably increased.

(3) In the first embodiment, the distance Dh between the heating wire 20 and the transmitting electrode 30 and the width Wh of the heating wire 20 satisfy a relationship of Dh≤Wh. According to this configuration, the distance Dh between the heating wire 20 and the transmitting electrode 30 is made smaller than the width Wh of the heating wire 20, and the transmitting electrode 30 is brought closer to the heating wire 20 at a high temperature. Since the amount of heat transferred to the transmitting electrode 30 from the heating wire 20 increases, the surface average temperature can be improved. In addition, by shortening the distance Dh between the heating wire 20 and the transmitting electrode 30 and increasing the distance Ds between the transmitting electrode 30 and the receiving electrode 40, the reaction strength can be increased stably.

(4) In the first embodiment, the width Wd of the transmitting electrode 30 and the width Wi of the receiving electrode 40 satisfy a relationship of Wd≤Wi. According to this relationship, the capacity formation of the capacitor by the two transmitting electrodes 30 and the one receiving electrode 40 can be stabilized.

(5) In the first embodiment, the width Wi of the receiving electrode 40 and the distance Ds between the transmitting electrode 30 and the receiving electrode 40 satisfy a relationship of Wi≤Ds. According to this relationship, as described with reference to the graphs of FIGS. 7 and 8, it is possible to prevent the user of the heater device 1 from feeling thermally uncomfortable, and to stably increase the response strength of the contact detection.

(6) In the first embodiment, the length and width of each wiring are set in such a manner that the relationship between the area Sb of the heater main body 2 and the sum Sw of the areas of the surfaces of each wiring whose normal is the thickness direction of the heater main body 2 satisfy 0.5×Sb≥Sw. As a result, the occupancy rate of the conductive material per unit area of the heater main body 2 can be reduced, and it is possible to prevent thermal discomfort from being caused when the user's finger or the like touches the heater main body 2.

### Second Embodiment

A second embodiment will be described. The second embodiment is different from the first embodiment in the shape of each wiring and the other parts are the same as those in the first embodiment, so only the parts different from the first embodiment will be described.

FIG. 9 is an enlarged view showing a part of the heater device 1 according to the second embodiment, and showing the portion corresponding to FIG. 4 referred to in the first embodiment. As shown in FIG. 9, in the second embodiment, the first heating wire 21, the first transmitting electrode 31, the receiving electrode 40, the second transmitting electrode 32, and the second heating wire 22 are formed in curved and wavy lines, and each wiring extends in parallel with each other. As described above, each wiring of the heater device 1 is not limited to a straight line as shown in the first embodiment, and may be curved or wavy as shown in the second embodiment.

Also in the second embodiment, the distance Dh between the heating wire 20 and the transmitting electrode 30 and the distance Ds between the transmitting electrode 30 and the receiving electrode 40 satisfy a relationship of Dh≤Ds. Further, the distance Dh between the heating wire 20 and the transmitting electrode 30 and the width Wh of the heating wire 20 satisfy a relationship of Dh≤Wh. In addition, the width Wd of the transmitting electrode 30 and the width Wi of the receiving electrode 40 satisfy a relationship of Wd≤Wi. The width Wi of the receiving electrode 40 and the distance Ds between the transmitting electrode 30 and the receiving electrode 40 satisfy a relationship of Wi≤Ds. Thereby, the heater device 1 of the second embodiment can also achieve the same effects as those of the first embodiment.

### Third and Fourth Embodiments

Next, third and fourth embodiments will be described. In general, the response strength of contact detection when an object such as a user's finger contacts or approaches near the tip of the receiving electrode 40 tends to be weaker than the reaction strength when an object comes into contact with or approaches the general portion of the receiving electrode 40 excluding the tip portion. Accordingly, the third and fourth embodiments described below are intended to increase the reaction strength near the tip portion of the receiving electrode 40.

### Third Embodiment

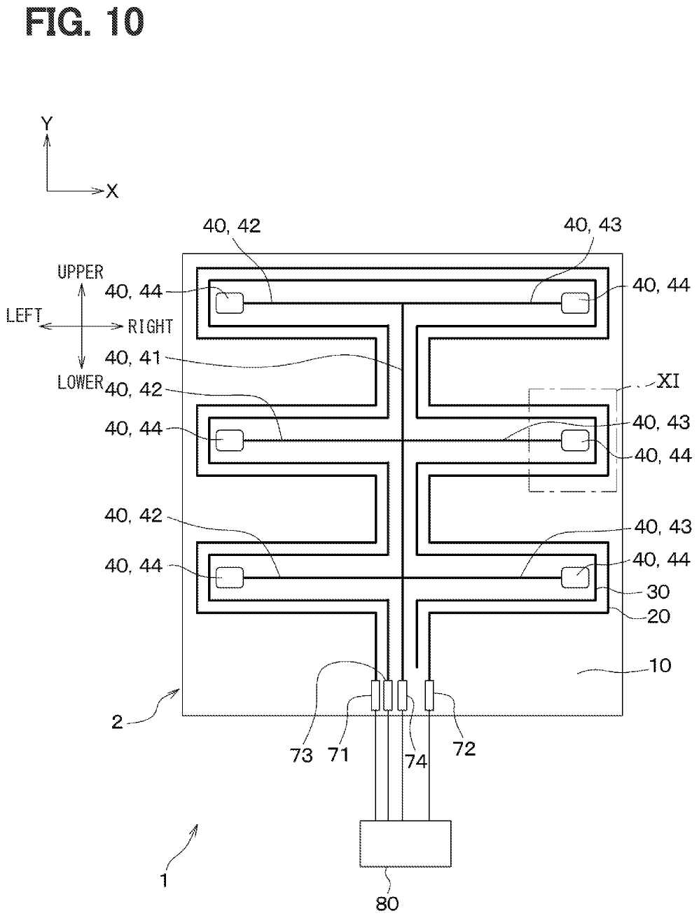

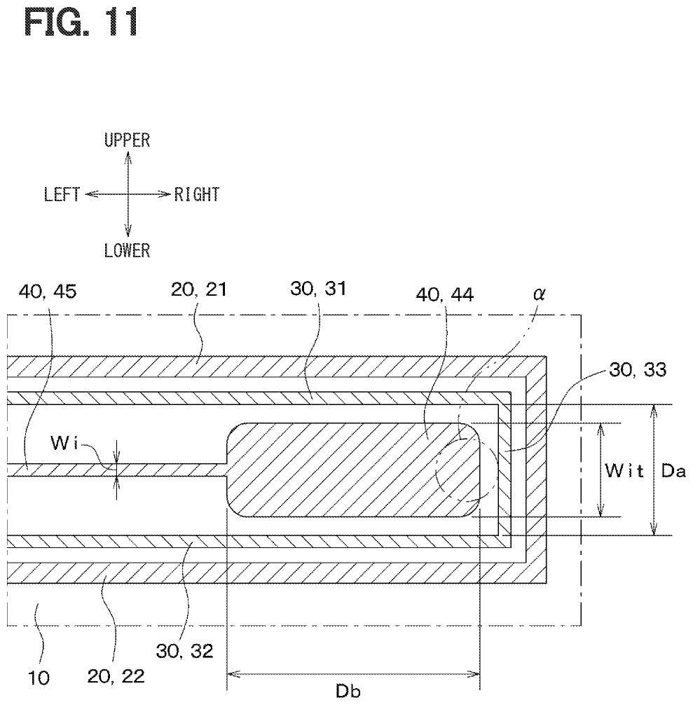

As shown in FIGS. 10 and 11, the heater device 1 of the third embodiment also has the heating wire 20, the transmitting electrode 30 and the receiving electrode 40 on predetermined layers of the insulating base material 10. Since the basic configuration of each wiring is the same as that explained in the first embodiment, the explanation thereof will be omitted.

FIG. 11 shows the configuration of the tip portion 44 of the receiving electrode 40 and its vicinity. The transmitting electrode 30 is provided so as to face three sides of the tip portion 44 of the receiving electrode 40. Hereinafter, for convenience of explanation, the transmitting electrodes 30 shown in FIG. 11 are referred to as a first transmitting electrode 31, a second transmitting electrode 32, and a third transmitting electrode 33, respectively. The first transmitting electrode 31 is a part that is arranged on the upper side of the paper surface of FIG. 11 with respect to the receiving electrode 40, and extends in parallel with the receiving electrode 40. The second transmitting electrode 32 is a part that is arranged on the side opposite to the first transmitting electrode 31 with respect to the receiving electrode 40 (that is, the lower side of the paper surface of FIG. 11 with respect to the receiving electrode 40), and extends in parallel with the receiving electrode 40. The third transmitting electrode 33 is a part that connects the first transmitting electrode 31 and the second transmitting electrode 32 on the tip portion 44 side of the receiving electrode 40 (that is, on the right side of the receiving electrode 40 in FIG. 11 with respect to the receiving electrode 40). The first transmitting electrode 31, the second transmitting electrode 32, and the third transmitting electrode 33 are continuously formed of the same material. The heating wire 20 is arranged outside the first transmitting electrode 31, the second transmitting electrode 32 and the third transmitting electrode 33.

In the third embodiment, the tip portion 44 of the receiving electrode 40 has a higher surface density than the general portion 45 of the receiving electrode 40. Specifically, when the line width of the tip portion 44 of the receiving electrode 40 is defined as Wit and the line width of the general portion 45 of the receiving electrode 40 is defined as Wi, a relationship of Wit>Wi is satisfied. As a result, the receiving electrode 40 has a configuration in which the surface density of the tip portion 44 is high by making the line width Wit of the tip portion 44 wider than the line width Wi of the general portion 45.

Due to such shape characteristics of the tip portion 44 of the receiving electrode 40, the change in capacitance ΔC increases when an object such as a user's finger contacts or approaches the tip portion 44 of the receiving electrode 40, so that the reaction strength can be ensured. As described above, since there is a relationship of C=f (shape characteristics×electrode length), even if the surface density of the tip portion 44 of the receiving electrode 40 is increased, the tip portion is only a part of the entire length of the receiving electrode 40. Therefore, although the contribution to the capacitor capacitance C is limited, the change capacitance ΔC can be increased.

Further, in the third embodiment, when Da is defined as the distance between the first transmitting electrode 31 and the second transmitting electrode 32, and Db is defined as the distance in the direction in which the general portion 45 extends at the tip portion 44 of the receiving electrode 40, a relationship Da≤Db is satisfied. As a result, the change in capacitance ΔC when an object such as a user's finger contacts or approaches the tip portion 44 of the receiving electrode 40 can be increased, and the reaction strength of the tip portion 44 of the receiving electrode 40 can be increased stably.

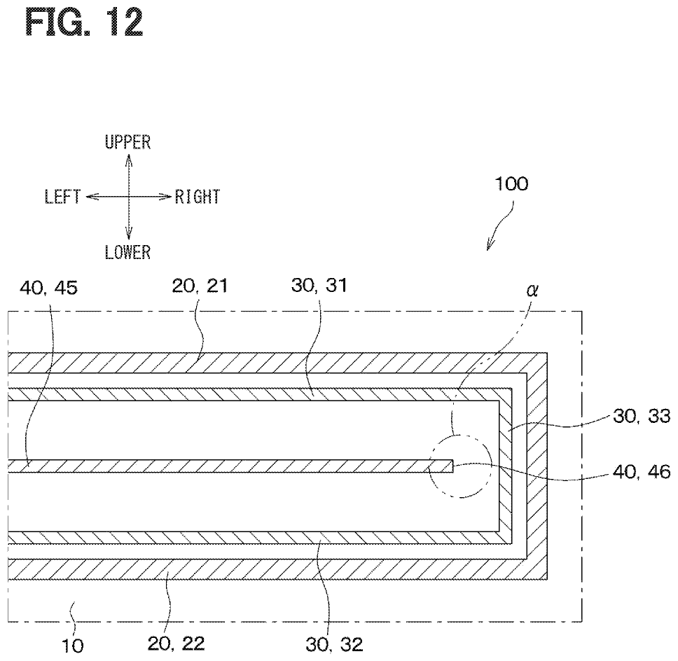

FIG. 12 shows part of the configuration of a heater device 100 of a comparative example for comparison with the heater device 1 of the third embodiment. As shown in FIG. 12, in the heater device 100 of the comparative example, the wiring width is formed to be the same from the general portion 45 to the tip portion 46 of the receiving electrode 40. The heater device 100 of the comparative example differs from the third embodiment in the shape of the tip portion of the receiving electrode 40, and is not a conventional technology.

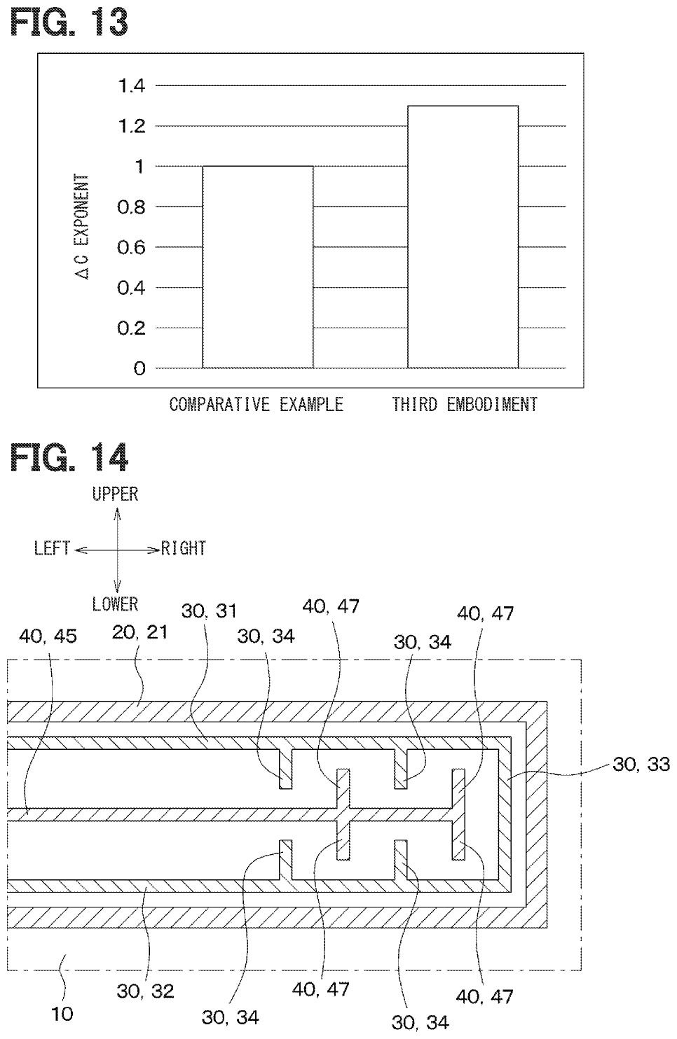

The graph of FIG. 13 shows simulation results of electromagnetic field analysis performed by the discloser for the heater device 1 of the third embodiment and the heater device 100 of the comparative example. In this simulation, an exponent of the change in capacitance ΔC when an object comes into contact with the center of the area indicated by the two-dot chain line circle α in FIGS. 11 and 12 is calculated.

According to the simulation results shown in FIG. 13, when the exponent of the change in capacitance ΔC in the heater device 100 of the comparative example is 1, the exponent of the change in capacitance ΔC in the heater device 1 of the third embodiment is about 1.3. As described above, in the heater device 1 of the third embodiment, it is possible to increase the reaction strength when an object contacts or approaches the vicinity of the tip portion 44 of the receiving electrode 40 by about 1.3 times that of the heater device 100 of the comparative example.

### Fourth Embodiment

As in the third embodiment, the fourth embodiment also aims to increase the reaction strength at the tip portion of the receiving electrode 40. As shown in FIG. 14, in the fourth embodiment, the tip portion of the receiving electrode 40 has a plurality of receiving branch parts 47 branched from a portion continuously extending from the general portion 45. The transmitting electrode 30 also has a plurality of transmitting branch parts 34 branched from the first transmitting electrode 31 and the second transmitting electrode 32 at positions corresponding to the receiving branch parts 47. The plurality of receiving branch parts 47 and the plurality of transmitting branch parts 34 are alternately provided in the direction in which the general portion 45 of the receiving electrode 40 extends. In FIG. 14, four receiving branch parts 47 are provided at the tip portion of the receiving electrode 40, and four transmitting branch parts 34 are provided at the transmitting electrode 30. However, the present disclosure is not limited to this configuration, and the number of receiving branch parts 47 and transmission branch parts 34 can be provided arbitrarily. Further, the transmitting branch parts 34 may be configured to branch off from the third transmitting electrode 33.

In the fourth embodiment described above as well, by providing the receiving branch parts 47 at the tip portion of the receiving electrode 40, the surface density of the tip portion of the receiving electrode 40 can be increased. Further, by providing the transmitting branch parts 34 on the transmitting electrode 30, it is possible to increase the surface density of the portion of the transmitting electrode 30 corresponding to the tip portion of the receiving electrode 40. As a result, in the fourth embodiment as well, due to such shape characteristics of the tip portion of the receiving electrode 40 and the shape characteristic of the transmitting electrode 30 surrounding the tip portion, the change in capacitance ΔC increases when an object such as a user's finger contacts or approaches the vicinity of the tip portion of the receiving electrode 40, so that the reaction strength can be ensured. As described above, since there is a relationship of C=f (shape characteristics×electrode length), even if the surface density of the tip portion of the receiving electrode 40 is increased, the tip portion is only a part of the entire length of the receiving electrode 40. Therefore, although the contribution to the capacitor capacitance C is limited, the change capacitance ΔC can be increased.

### Other Embodiments

(1) In each of the above-described embodiments, each wiring included in the heater device 1 satisfies a relationship of Dh1≤Ds1 and Dh2≤Ds2. The relationship is not limited to this configuration, and a relationship of Dh1<Ds1 and Dh2<Ds2 may be satisfied. As a result, the above-mentioned wiring has a greater effect than wiring that satisfies a relationship of Dh1=Ds1 and Dh2=Ds2. In addition, if necessary, each wiring may satisfy a dimensional relationship that do not include manufacturing tolerances, etc. (for example, Dh1×1.1<Ds1 and Dh2×1.1<Ds2) with respect to the dimensional relationship of Dh1=Ds1 and Dh2=Ds2.

(2) In each of the above-described embodiments, each wiring included in the heater device 1 satisfies a relationship of Dh1≤Wh1 and Dh2≤Wh2. The relationship is not limited to this configuration, and the wiring may satisfy a relationship of Dh1<Wh1 and Dh2<Wh2. As a result, the above-mentioned wiring has a greater effect than wiring that satisfies a relationship of Dh1=Wh1 and Dh2=Wh2. In addition, if necessary, each wiring may satisfy a dimensional relationship that do not include manufacturing tolerances, etc. (for example, Dh1×1.1<Wh1 and Dh2×1.1<Wh2) with respect to the dimensional relationship of Dh1=Wh1 and Dh2=Wh2.

(3) In each of the above-described embodiments, each wiring included in the heater device 1 satisfies a relationship of Wd1≤Wi and Wd2≤Wi. The relationship is not limited to this configuration, and the wiring may satisfy a relationship of Wd1<Wi and Wd2<Wi may be satisfied. As a result, the above-mentioned wiring has a greater effect than wiring that satisfies a relationship of Wd1=Wi and Wd2=Wi. In addition, if necessary, each wiring may satisfy a dimensional relationship that do not include manufacturing tolerances, etc. (for example, Wd1×1.1<Wi and Wd2×1.1<Wi) with respect to the dimensional relationship of Wd1=Wi and Wd2=Wi.

(4) In each of the above-described embodiments, each wiring included in the heater device 1 satisfies a relationship of Wi≤Ds1 and Wi≤Ds2. The relationship is not limited to this configuration, and the wiring may satisfy a relationship of Wi<Ds1 and Wi<Ds2. As a result, the above-mentioned wiring has a greater effect than wiring that satisfies a relationship of Wi1=Ds1 and Wi=Ds2. In addition, if necessary, each wiring may satisfy a dimensional relationship that do not include manufacturing tolerances, etc. (for example, Wi×1.1<Ds1 and Wi×1.1<Ds2) with respect to the dimensional relationship of Wi=Ds1 and Wi=Ds2.

(5) In the above-described third embodiment, each wiring included in the heater device 1 satisfies the relationship of Da≤Db, but is not limited to this relationship, and the wiring may satisfy a relationship of Da<Db. As a result, the above-mentioned wiring has a greater effect than wiring that satisfies a relationship of Da=Db. In addition, if necessary, each wiring may satisfy a dimensional relationship that do not include manufacturing tolerances, etc. (for example, Da×1.1<Db) with respect to the dimensional relationship of Da=Db.

The present disclosure is not limited to the above-described embodiments, and can be appropriately modified. The above-described embodiments are not independent of each other, and can be appropriately combined together except when the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Furthermore, a shape, positional relationship or the like of a structural element, which is referred to in the embodiments described above, is not limited to such a shape, positional relationship or the like, unless it is specifically described or obviously necessary to be limited in principle.

What is claimed is:

1. A heater device, comprising:
an insulating base material;
a heating wire having a first heating wire and a second heating wire and generating heat when energized;
a receiving electrode provided between the first heating wire and the second heating wire;
a transmitting electrode having a first transmitting electrode provided between the first heating wire and the receiving electrode and a second transmitting electrode provided between the second heating wire and the receiving electrode; and
a control unit configured to control energization to the heating wire so as to set temperature of an area where the heating wire is arranged on the insulating base material to a predetermined temperature, and to reduce an amount of energization to the heating wire from a normal state or to stop the energization, when contact or proximity of an object is detected by a change in capacitance between the transmitting electrode and the receiving electrode, wherein
the first heating wire, the first transmitting electrode, the receiving electrode, the second transmitting electrode, and the second heating wire are provided so as to extend side by side in this order on a predetermined layer of the insulating base material,
a distance between the first heating wire and the first transmitting electrode is defined as Dh1, a distance between the first transmitting electrode and the receiving electrode is defined as Ds1, a distance between the second heating wire and the second transmitting electrode is defined as Dh2, and a distance between the second transmitting electrode and the receiving electrode is defined as Ds2, and
a relationship of Dh1≤Ds1 and Dh2≤Ds2 is satisfied.

2. The heater device according to claim 1, wherein
a width of the first heating wire is defined as Wh1, and a width of the second heating wire is defined as Wh2, and
a relationship of Dh1≤Wh1 and Dh2≤Wh2 is satisfied.

3. The heater device according to claim 1, wherein
a width of the first transmitting electrode is defined as Wd1, a width of the second transmitting electrode is defined as Wd2, and a width of the receiving electrode is defined as Wi, and
a relationship of Wd1≤Wi and Wd2≤Wi is satisfied.

4. The heater device according to claim 1, wherein
a width of the receiving electrode is defined as Wi, and
a relationship of Wi≤Ds1 and Wi≤Ds2 is satisfied.

5. The heater device according to claim 1, wherein
an area of the surface of the insulating base material on which the heating wire, the receiving electrode, and the transmitting electrode are provided is defined as Sb,
the sum of the areas of the surfaces of the heating wire, the receiving electrode, and the transmitting electrode whose normal is a thickness direction of the insulating base material is defined as Sw, and
a relationship of 0.5×Sb≥Sw is satisfied.
